(19) United States
(12) Patent Application Publication
(10) Pub. No.: US 2020/0305650 A1
(43) Pub. Date: Oct. 1, 2020

(54) The cooking brackets components

(71) Applicant: Gregory Biscardi, San Jose, CA (US)

(72) Inventor: Gregory Biscardi, San Jose, CA (US)

(21) Appl. No.: 16/366,156

(22) Filed: Mar. 27, 2019

(51) Int. Cl. A47J 47/16

(52) U.S. Cl. CPC A47J 47/16

(57) ABSTRACT

A modular compact portable meal preparation apparatus comprising a holding assembly that is assembled from individual components to form a complete apparatus. Each holding assembly is provided with redundant locations for heating means thereby facilitating preparation of multiple dishes or courses simultaneously. Said apparatus has dimensions allowing operation within the confines of limited spaces, and disassembles for compact storage or transport. Alternate embodiments of the apparatus include means of attachment to the outer edge of picnic tables, tailgates, and other suitable objects. Additional alternate embodiments of the apparatus include means of attachment to the inner or outer surface of cabinet doors, walls, and other similar surfaces.

### BACKGROUND OF THE INVENTION

The present invention relates to the art of cooking and, more particularly, the present invention relates to a method and an apparatus for cooking multiple individual dishes simultaneously in extremely limited space and storing cooking pots, pans and lids compactly in an organized manner.

Generally, disorganized pots, pans, and lids not only take up a lot of space in home kitchen cabinets, and are usually a mess, but make it difficult to locate the matching pieces or needed lids.

Currently there are many types of organizers available on the market however these have many deficiencies including limited capacity. The types made for cabinets wear out quickly, the outer doors get stained, faded, scratched, and etc. Few options are available for motorhomes, camping trailers, and extremely small modular homes. No matter their design, organizers are only for storage, and have no solutions to the issue of cooking using multiple pots and pans simultaneously in limited space or outside of a traditional kitchen.

The present invention solves all these issues at the same time, providing not only organized, compact storage for all the various cooking implements, but gives the consumer the ability to cook multiple dishes simultaneously in a variety of environments including tailgates, picnic tables, motorhomes, camptrailers, and outdoors in addition to home and apartment kitchens.

### BRIEF SUMMARY OF THE INVENTION

The primary object of the present invention is to provide a portable compact modular meal preparation apparatus in which individual components are easily brought into cooperation to complete an operative apparatus and removed from cooperation for storage or transport, whereby use of the apparatus is possible in a greatly increased range of circumstances.

Another object of the present invention is to provide a meal preparation apparatus free from the previously discussed disadvantages and limitations of currently available products.

An additional object of the present invention is to provide a meal preparation apparatus comprised of easily manufacturable lightweight components to minimize shipping and handling expense.

One preferred embodiment of the present invention comprises at least one holding assembly having a torsionally stiff vertically disposed upright support pillar of sufficient strength and suitable material composition and a base component of sufficient strength and suitable material composition having the general attributes of the base assembly of a conventional turntable device commonly referred to as a Lazy Susan. Said base component is provided with a centrally located mounting site for detachable attachment or connection to said upright support pillar such that when said base component is placed on a solid level surface said upright support pillar is supported by said base component in a manner whereby 360 degree rotation of said upright support pillar is possible.

The apparatus according to the invention includes at least one pair of cooking arm assemblies, and which in one embodiment each cooking arm assembly includes a mounting bracket, heating means holder, cooking implement holder, and cooking implement lid holder where each of said components is of sufficient strength and suitable material composition, cooking implement being defined as items commonly referred to as cooking pots, pans, and other objects used for such purpose. Said cooking implement holder and cooking implement lid holder are shaped to hold and support standard cook pots and pans, said cooking implement holder being provided with adjustable attachment or connection to said mounting bracket thus allowing accommodation for varying sizes of cooking implements.

In the preferred embodiment said heating means holder, cooking implement holder and cooking implement lid holder are permanently attached in a spaced apart manner along one axis of said mounting bracket however other embodiments may include detachable attachment or other arrangement of said components. Said mounting bracket is provided with means of detachable attachment or connection at an appropriate location along the longitudinal axis of said upright support pillar thereby forming an apparatus of generally pyramidal structure and whereby rotation of said upright support pillar results in rotation of all attached cooking arm assemblies. When attached to said upright support pillar said mounting bracket is positioned such that said heating means holder, cooking implement holder and cooking implement lid holder components define separate horizontally disposed planes along the vertical axis of said upright support pillar with said heating means holder closest to the base component and said cooking implement holder directly above the heating means holder.

The apparatus according to the invention is provided with heating means, each heating means holder of the preferred embodiment having proportions suitable to accommodate a conventional multi-purpose canned heat unit. One type of such conventional canned heat unit is commonly referred to as Sterno, manufactured under U.S. Pat. No. 8,512,424, however an other appropriate type of canned heat unit may be employed in lieu thereof. Thus, when used as directed by product instructions, each canned heat unit provides heat to the cooking implement supported by the cooking implement holder located directly above the canned heat unit. Additional alternate embodiments of said heating means holder designed to utilize battery powered or other heating means other than those specifically herein referenced are also possible.

Consequently, the apparatus provides the ability to employ multiple cook pots and pans simultaneously within an extremely small space; an area having a circular footprint with radius only slightly larger than the diameter of the largest cooking implement employed.

Alternate embodiments of the apparatus according to the invention having the same or similar characteristics as those previously defined, said alternate embodiments further comprising mounting brackets shaped to fit standard picnic tables, other table shapes, vehicle tailgates or other applications may be desirable and are also possible without departing from the scope of the invention.

An additional alternate embodiment of the apparatus according to the invention includes an upright support pillar having mounting sites for detachable attachment to a cabinet door or kitchen wall, thus allowing the apparatus to also be used as a compact organizing storage unit.

### BRIEF DESCRIPTION OF THE SEVERAL VIEWS OF THE DRAWINGS

For a better understanding of the present invention and to show more clearly how it may be carried into effect, reference is made by way of example to the accompanying drawings, which show an apparatus according to one embodiment of the present invention and in which:

FIG. 1 is an elevated view of an embodiment of the apparatus according to the invention having one cooking arm assembly indicated by 9 and the complete apparatus indicated by 1. FIG. 1 also shows the following components: base component, upright support pillar, mounting bracket, implement lid holder, implement holder, heating means holder, and securing flange, indicated by 2, 3, 4, 5, 6, and 7, and 8 respectively.

FIG. 2 is exploded side view of the complete apparatus showing the connectivity between base component 2 and upright support pillar 3 at site E, and the connectivity between upright support pillar 3 and cooking arm assembly 9 at site D.

FIG. 3 is an elevated perspective view of cooking arm assembly 9 showing the directional movement of implement lid holder 5 at site A, the directional adjustment of implement holder 6 referenced by B, and the directional adjustment of heating means holder 7 referenced by C.

FIG. 4 is a exploded side view of cooking arm assembly 9 showing the connectivity between mounting bracket 4 and implement lid holder 5, implement holder 6, heating means holder 7, and securing flange 8.

### DETAILED DESCRIPTION OF THE EMBODIMENTS

It is to be understood that the embodiments of the present invention disclosed herein are merely exemplary of the invention, which may be embodied in various forms. Therefore, specific structural and functional details disclosed herein are not to be interpreted as limiting.

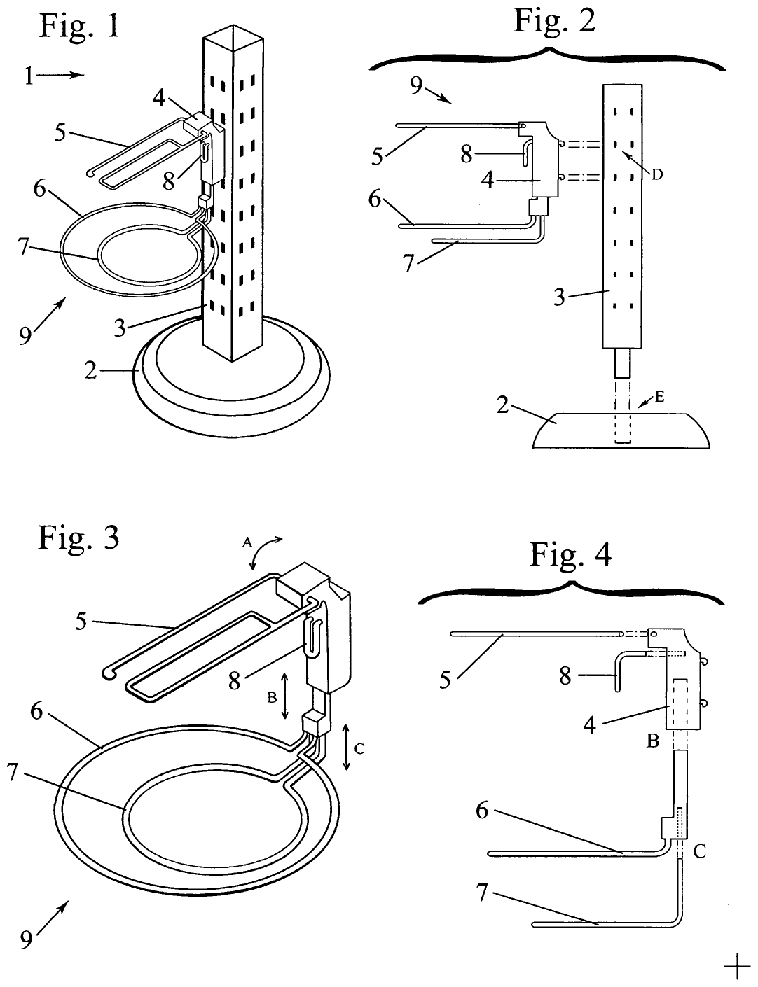

Referring now to the drawings, in which some proportions have been exaggerated for the purposes of conceptual illustration, the description of the invention is best understood by commencing with reference to FIG. 1 where a complete meal preparation apparatus according to the invention is shown and is indicated generally as 1. It may be seen to include a base component 2 of sufficient strength and suitable material composition having the general attributes of the base assembly of a conventional turntable device commonly referred to as a Lazy Susan, and a torsionally stiff vertically disposed upright support pillar 3 of sufficient strength and suitable material composition. Said meal preparation apparatus further includes at least one cooking arm assembly of sufficient strength and material composition indicated as 9 in FIGS. 1, 2, and 3. It is to be understood that for the purpose of conveying a clear, concise understanding of the invention the embodiment illustrated in the drawings and described herein includes only one cooking arm assembly whereas the preferred embodiment includes four such cooking arm assemblies spaced at intervals around the circumference of the upright support pillar.

As shown in FIG. 2 base component 2 includes a vertically oriented mounting site E for attachment of upright support pillar 3 which is detachably attached thereto in such manner that 360 degree rotation of upright support pillar 3 around a vertical axis is possible.

Referring again to FIG. 2, cooking arm assembly 9 comprises a mounting bracket 4, cooking implement lid holder 5, cooking implement holder 6, and heating means holder 7 where each of said components is of sufficient strength and suitable material composition, cooking implement being defined as items commonly referred to as cooking pots, pans, and other objects used for such purpose. Referring again to FIG. 2, upright support pillar 3 includes at least one mounting site D for detachable attachment of cooking arm assembly 9 whereby rotation of upright support pillar 3 results in rotation of all attached cooking arm assemblies 9.

As shown in FIG. 3, cooking implement lid holder 5, cooking implement holder 6 and heating means holder 7 are permanently attached in a spaced apart manner along one axis of mounting bracket 4, however other embodiments may include detachable attachment or other arrangement of said components. Heating means holder 7 has proportions suitable to accommodate a conventional, commercially available multi-purpose canned heat unit. One type of such conventional canned heat unit, commonly referred to as Sterno, is manufactured under U.S. Pat. No. 8,512,424, however an other appropriate type of canned heat unit may be employed in lieu thereof. Additional alternate embodiments of heating means holder 7 designed to utilize battery powered, propane powered, electrically powered, or other heating means other than those specifically herein referenced are also possible without departing from the scope of the invention.

When attached to upright support pillar 3 mounting bracket 4 is positioned such that cooking implement lid holder 5, cooking implement holder 6 and heating means holder 7 define separate horizontally disposed planes along the vertical axis of upright support pillar 3 with heating means holder 7 closest to base component 2 and cooking implement holder 6 directly above heating means holder 7, as shown in FIG. 2.

Mounting bracket 4, shown in FIGS. 1, 2 and 4, includes an adjustable mounting point for attachment of cooking implement lid holder 5 whereby the spacial position of cooking implement lid holder 5 may by modified from a generally horizontal plane to a more vertical one as indicated by A in FIG. 3, thereby allowing the user to lift the lid of the cook pot or pan while apparatus 1 is in use without removing said lid from cooking implement lid holder 5. Mounting bracket 4 further includes mounting point B for adjustable attachment of cooking implement holder 6, also shown in FIG. 3, thereby providing the ability to selectively effect the elevation of cooking implement holder 6 relative to cooking implement lid holder 5 thus allowing cooking arm assembly 9 to accommodate varying sizes of cooking implements.

Mounting bracket 4 further includes means of securing the cooking implement to mounting bracket 4 and therefore to apparatus 1 while in use. In the preferred embodiment said securing means is accomplished by mounting bracket 4 being provided with a protruding portion shaped to form a flange, shown as 8 in FIGS. 1, 2, 3 and 4, extending at an acute angle from the main body of mounting bracket 4 thereby creating a space between said flange 8 and the main body of mounting bracket 4 large enough to allow the rim of standard cooking implements to fit between flange 8 and said main body of mounting bracket 4, however other means of securing the cooking implement to mounting bracket 4 are possible without departing from the scope of the invention. When apparatus 1 is used as intended a cooking implement is placed onto implement holder 6. Implement holder 6 is then adjusted upwards along the longitudinal axis of mounting bracket 4 with the cooking implement positioned such that the rim of the supported cooking implement enters the space between flange 8 and the main body of mounting bracket 4, said upward adjustment continuing until no further upward adjustment is possible and said cooking implement rim is secured therewithin.

Referring again to FIG. 3, mounting bracket 4 further includes mounting point C for adjustable attachment of heating means holder 7, whereby an optimal distance between the heating means and the lower extremity of the cooking implement may be achieved such that the desired amount of heat is transferred to said cooking implement.

Alternate embodiments of the apparatus according to the invention having the same or similar characteristics as those previously defined and further comprising mounting brackets shaped to fit standard picnic tables, other table shapes, vehicle tailgates, or other applications may be desirable and are also possible without departing from the scope of the invention.

An additional alternate embodiment of the apparatus according to the invention includes an upright support pillar having mounting sites for detachable attachment to a cabinet door or kitchen walls, thus allowing the apparatus to also be used as a compact organizing storage unit.

What is claimed is:

1. A meal preparation apparatus wherein said apparatus comprises:
a. upright support pillar of sufficient strength dimension and appropriate material composition comprising an elongated and torsionally stiff component oriented in a substantially vertical direction thus having an upper end and a lower end;
b. base component having sufficient strength dimension and appropriate material composition and provided with a centrally located mounting site for detachable attachment or connection to said upright support pillar such that the lower end of said upright support pillar is rotationally mountable therein;
c. one or more cooking arm assemblies having sufficient strength and appropriate material composition and having means of attachment to said upright support pillar whereby rotation of said upright support pillar around a vertical axis results in rotation of all of said attached cooking arm assemblies.

2. Meal preparation apparatus in accordance with claim 1 wherein:
a. said upright support pillar is provided with at least one mounting site for detachable attachment or connection of said cooking arm assemblies;
b. said base component has sufficient weight and dimensions such that a stable foundation is provided for said apparatus when used in a manner consistent with the intended purpose.

3. Meal preparation apparatus in accordance with claim 1 wherein said cooking arm assembly comprises:
a. mounting bracket having means of attachment to said upright support pillar;
b. heating means holder having means of attachment to said mounting bracket and having shape and dimension suitable to support and hold an appropriate heating means, which in the preferred embodiment comprises a torsionally stiff ring having diameter in proportion to fit common commercially available canned heat products;
c. cooking implement holder having means of attachment to said mounting bracket and having shape and dimension appropriate to hold and support cooking implements appropriate for use with the apparatus;
d. cooking implement lid holder having means of attachment to said mounting bracket and to cooking implement lids and having shape and dimension appropriate to hold and support the lids of cooking implements appropriate for use with the apparatus.

4. Meal preparation apparatus in accordance with claim 3 wherein:
a. said mounting bracket further includes means of adjustable attachment or connection to said cooking implement holder thereby providing the ability to selectively effect the elevation of said cooking implement holder relative to said cooking implement lid holder thus allowing said implement holder to accommodate varying sizes of cooking implements;
b. said mounting bracket further includes means of adjustable attachment or connection to said heating means holder thereby providing the ability to selectively effect the elevation of said heating means holder relative to said cooking implement holder thus providing for an optimal distance between the heating means and the lower extremity of the cooking implement such that the desired amount of heat is transferred to said cooking implement;
c. said cooking implement lid holder further includes means of adjustment whereby the spacial position of the cooking implement lid may by modified from a generally horizontal plane to a more vertical one.
d. said mounting bracket further includes means of securing a cooking implement to said mounting bracket.

5. Meal preparation apparatus in accordance with claim 1 wherein:
a. alternate embodiments of said meal preparation apparatus further include means of detachable attachment or connection to picnic tables, benches, tailgates, and other suitable objects;
b. additional alternate embodiments of said meal preparation apparatus further include means of detachable attachment or connection to the vertical surface of cabinet doors, walls, and other similar surfaces.

6. (canceled)

7. (canceled)
